(19) United States
(12) Patent Application Publication
(10) Pub. No.: US 2006/0097046 A1
(43) Pub. Date: May 11, 2006

(54) Intelligent air travel tag for asset self-tracking

(75) Inventors: Marcelo Daniel Baru Fassio, Surrey (CA); Marcelo Yannuzzi Sanchez, Barcelona (ES); Gonzalo Picun Miller, Ceroux-Mousty (BE)

Correspondence Address: BARU FASSIO, Marcelo Daniel, 159-15236 36th Ave., SURREY, BC, V3S 2B3, CA

(73) Assignee: DEFERO SYSTEMS INC.

(21) Appl. No.: 11/256,161

(22) Filed: Oct. 24, 2005

Related U.S. Application Data
(60) Provisional application No. 60/621,059, filed on Oct. 25, 2004.

(51) Int. Cl. G06Q 30/00; G08B 13/14; G08B 5/22

(52) U.S. Cl. 235/385; 340/572.1; 340/825.49

(57) ABSTRACT

A system for luggage self-tracking/identification during air travel involves a programmable, wireless LAN active transceiver preferably located inside each piece of luggage, with controlled access to the airlines' luggage tracking networks. Prior to a flight, each transceiver is loaded with the passenger's itinerary, and logged in the airline's network at check-in. Each transceiver is uniquely identifiable by the luggage tracking network. An example of a preferred identifier would be the utilization of its Medium Access Control (MAC) and its alphanumeric serial keyword to provide unique and secure registration/identification of the transceiver in the airline's network. During the trip, which may include different stopovers before reaching the final destination, the transceiver is able to automatically compare its programmed itinerary with its current location via wireless access to the airports and aircraft wireless LANs. In this way, the transceiver is able to notify airline personnel if there is a disagreement between its programmed itinerary and its current location, thus preventing misrouting. The transceiver's itinerary can be wirelessly re-programmed by airline personnel/network to account for flight changes or delays. Finally, the transceiver has an internal timer that starts counting down from the expected “total traveling time”, accounting for flight changes or delays. If this timer elapses without the itinerary being complete, the transceiver connects to a wireless access point (hotspot) to report itself as a missing luggage, avoiding a worldwide tracking initiative and speeding up recovery time.

### CROSS-REFERENCE TO RELATED APPLICATION

This application claims priority to copending U.S. provisional application entitled, “INTELLIGENT ACTIVE TAG AND METHOD FOR LUGGAGE SELF-TRACKING/IDENTIFICATION DURING AIR TRAVEL” having U.S. Ser. No. 60/621,059, filed Oct. 25, 2004, which is entirely incorporated herein by reference.

### BACKGROUND OF THE INVENTION

This invention relates to an automated system for self-tracking/identification of assets handled by airline companies.

Airline industry statistics show that only 80% of luggage is correctly processed using optical scanning of bar codes on luggage tags. This suggests that an estimated 20 million bags are mislaid or incorrectly routed annually by the world's airlines. This results in annual direct costs of tens of millions of dollars for recovering and delivering misrouted luggage, and indirect costs resulting from customer dissatisfaction.

Recently, some airlines have started to run pilot tests in which short-range, passive radio frequency identification (RFID) disposable tags are used to track luggage from check-in to loading on planes. While such systems may offer improved accuracy, implementing such systems requires material infrastructure changes to all printed bar-code-based baggage handling equipment on a worldwide level. Other disadvantages of disposable RFID tags that limit market penetration of such RFID tag systems include:
the higher cost per tag relative to bar-code tags;
unproven durability;
unproven performance in industrial environments; and,
the passive nature of proposed RFID tag systems which require human intervention to identify, report, and locate missing baggage.

Besides these recent pilot tests using disposable RFID tags by certain airlines, the following patents also describe luggage tracking systems based on some sort of RFID tags:

U.S. Pat. No. 5,576,692 to Tompkins et al., Nov. 19, 1996;

U.S. Pat. No. 6,476,718 B1 to Cartwright et al., Nov. 5, 2002.

Tompkins et al. describes a nationwide airport tracking system and method based on a non-disposable beeper-paging unit attached to each piece of luggage. The system can cause selected beeper units to beep when remotely activated within a geographic area served by a paging system. A first disadvantage of the Tompkins et al. system is the fact that luggage misrouting must take place within a certain geographic area. In reality luggage can be misrouted to anywhere in the world. A second disadvantage is that a tracking initiative is brought into action once the luggage does not arrive at the final destination. This implies that there is no misrouting prevention during travel, which may result in a piece of luggage ending up thousands of miles away from its scheduled destination. Cartwright et al. suffers the disadvantages of the short-range RFID tags mentioned above.

There is a need for a worldwide, intelligent luggage tracking system for air travel. The inventors have determined that a system that autonomously accounts for flight changes or delays based on the scheduled itinerary by which the luggage should travel, and automatically reports the luggage whereabouts if the itinerary is not completed in the expected total traveling time, can best address this need. Specifically, there is a need for a low-cost active luggage tracking system able to work within existent airport/aircraft technological infrastructure. There is also a need for a “user-friendly” luggage tracking system for air travel. It would be advantageous to allow the luggage owner to initiate tracking initiatives if their luggage is misdirected.

### SUMMARY OF THE INVENTION

Today's airline industry demands broadband wireless infrastructure solutions at airports and in aircraft. World airlines are starting to provide wireless Internet access to all passengers on board aircraft (e.g. Lufthansa's FlyNet®), and are using wireless LANs for providing services and sharing resources at airports. The inventors have determined that a worldwide, intelligent luggage tracking system can utilize the airlines' wireless LAN infrastructures.

This invention provides a worldwide, intelligent luggage self-tracking/identification system for air travel based on low-cost, low-power wireless LAN active transceivers, which work by connecting to the airlines' wireless LAN networks at airports and in aircraft. One transceiver is associated with each piece of checked-in luggage. The transceiver is preferably inside the luggage. The transceiver preferably includes a tether to attach it to the luggage or is received in a pocket in the luggage such that the transceiver is unlikely to become separated from the luggage.

Since each reusable, preferably rechargeable, luggage transceiver has a unique identification register, a passenger could make a one-time purchase to acquire the transceiver (this purchase may be included as part of a booking fee or it may be subsidized by airlines for preferred customers). The transceivers may use any suitable communication protocol(s) and any suitable wireless networking technology to communicate with the LAN networks. At present, technologies such as IEEE 802.11b, 802.11g or Bluetooth in the ISM frequency band are feasible technologies to provide the transceivers with the desired ability to communicate with a LAN. Use of transceivers according to this invention does not preclude continued use of the bar-code system.

Prior to a flight, information specifying the passenger's itinerary is loaded into the transceiver. Some preferable methods of loading the itinerary information are as follows:

1. By performing an automatic download of the itinerary from the airline's web page using the passenger's frequent flyer number or other identification information (it would be preferable for the transceiver to be equipped with a USB port or similar interface to allow for programmability by any means but preferably by PC based programmability).

2. By manually entering the itinerary into the transceiver using an alternative interface.

3. By wirelessly programming the transceiver using the passenger's personal computer, PDA, cell phone, or other technical device.

4. By an airline employee during check-in (or electronic check-in), using the wireless LAN access capabilities of the transceiver. Other suitable methods may also be used to store itinerary information in the transceiver.

At check-in, the airline agent who receives each piece of luggage issues a wireless registration process (the same procedure applies to electronic check-ins). If the transceiver inside a piece of luggage was not previously configured with the itinerary, the employee uploads the itinerary into the transceiver and registers it in the airline network. If the transceiver was previously configured and the itinerary is correct, then the transceiver is registered in the airline network. If, the passenger has more than one piece of luggage, a simultaneous registration may be applied using a broadcast application, preferably using a Multicast Group Address.

Since the access technology proposed is preferably a wireless LAN, any unique identifier (an “ID”) can be assigned to each transceiver. A preferred example of an ID is the use of a combination of the MAC address and an alphanumeric serial keyword to provide a unique and secure registration/identification of the transceiver within the airline network. The preferred infrastructure and capabilities needed to achieve these operations at check-in are as follows:

1. An airline hotspot located at the check-in counters for luggage transceiver registration.

2. Access to the wireless LAN at each airline check-in terminal.

3. The transceivers shall be able to connect to this wireless LAN.

4. In order to accomplish the registration process, the airline terminals shall be able to discover new transceivers within the wireless LAN.

5. At any given moment, within an airline terminal hotspot one shall be able to identify all luggages equipped with a transceiver. Although several new transceivers could be simultaneously discovered, the unique ID of each transceiver allows authorized employees (or the electronic check-in terminal) to identify them, and guarantees that each transceiver is appropriately registered.

6. Once the registration process is completed, the transceivers are loaded with the complete travel itinerary including flight numbers, airlines and departure times. Moreover, the transceiver is now registered in the airline system, which in turn allows the airline to share this information with other airlines listed in the travel itinerary.

7. The employee may attach the traditional bar-code tag or other handling devices to the luggage.

In this framework, it is preferable that hotspots are provided in all areas that service or handle luggage including, but not limited to:
holding areas;
transportation equipment, loading areas;
check-in counters, including but not limited to airline agent assisted and electronic check-ins;
and aircraft luggage compartments.

While (or after) being loaded onto a plane, each transceiver attempts to connect to the on-board wireless LAN (which may be a temporary mobile hotspot if the aircraft is not equipped with Internet service). Once a connection is established, the itinerary present in the transceiver allows it to confirm the flight number. Comparison of the flight identification stored in the transceiver to the flight information identifying the destination of the aircraft in which the luggage is located may be performed in any suitable manner. For example:
Each transceiver may transmit information that identifies the flight that the transceiver should be on according to the itinerary information in the transceiver and a processor in the on-board LAN may determine whether any misrouted luggage is on board.
An on-board LAN may broadcast information identifying the current LAN to all on-board transceivers. Processors in each transceiver may compare the received flight information to the itinerary stored in the transceiver.
   If the flight is correct, the transceiver updates the itinerary, if necessary, and waits for a “go to sleep” instruction from the on-board wireless LAN server. Throughout the sleeping time, battery power is conserved during the flight, yet allowing for controlled transmission and reception to and from the transceiver which complies with air travel regulations pertaining on-board electronic devices. Rather than programming the transceiver to sleep for the expected total flying time, a permanent on-board wireless LAN server may program several “sleeping times” throughout the flight, to account for flying time variations. In any case, once the transceiver is waken up from each “sleeping period”, it waits for the next “go to sleep” instruction or for the “flight arrival” instruction, in which case it updates its itinerary (if needed) and attempts to connect to a new wireless LAN.

Should the luggage be routed to the incorrect flight, the transceiver triggers an alarm that allows airline personnel in charge of handling luggage up to and including loading luggage into the aircraft to become aware of the mistake, and redirect the piece of luggage to the correct plane, or other routing by means of the bar-code tag or the transceiver's itinerary if the bar-code tag came off (a new tag can be printed by airline personnel and re-attached). An audible alarm type is preferred.

Any misdirected luggage may be intercepted and redirected at any point in the transition from departure to arrival. For example, following the alarm of misplaced luggage in an aircraft, the position of the misplaced luggage may also be determined by using signal-strength measurements from at least two hotspots in the luggage compartment. Based on these measurements, the position of the misplaced luggage in the compartment can be displayed on an LCD monitor in such area or in a hand-held device, for airline personnel to remove it. If a misplaced luggage is not re-directed before take off, it will follow the same “sleep-awake” procedure during the flight described before. However, an “alarm flag” will be set inside the transceiver in order for it to report as “missing” in the next association to a wireless LAN.

A second aspect of the invention are the timers “T_{ToFitDep}=time to first departure” and “T_{TOTAL}=total traveling time”. Both timers are initiated from the transceiver's itinerary every time the itinerary is modified. The first timer allows the transceiver to calculate if the time to the first scheduled departure has elapsed or not. If the time to the first departure has elapsed without the transceiver having connected to the corresponding on-board wireless LAN, the transceiver will report itself as “missing” at the next connection to a wireless LAN. This speeds up the re-routing of mishandled luggage. The second timer plays an important role for flights with multiple connections. The idea is to have a timer in the transceiver that starts counting down, from the total traveling time, as soon as the itinerary starts. If the timer expires without the luggage having completed its programmed itinerary, the transceiver will report its location in the next connection to a wireless LAN. Consequently, it is preferable that hotspots may be available at “luggage claim areas” at each airport. In such case, the passenger could also be automatically informed, e.g. by e-mail, of the luggage's whereabouts. Airline personnel may wirelessly request the transceiver to “beep” in order to identify the missing luggage in the location where it reported, or they may use signal-strength measurements to locate and identify the missing luggage, as previously described for misplaced luggage on board an aircraft.

Systems according to the invention may be configured to permit each passenger to check to find out whether his or her luggage was loaded on the plane immediately after take off. If a passenger confirms that his/her luggage was not loaded on the aircraft, a missing baggage report may be initiated using the on-board intranet. This optional capability further speeds up the re-routing of mishandled luggage. Systems having this feature are especially useful for luggage that must arrive on time (i.e. business travel, sport competitions, short holidays, etc.).

Finally, apparatus and methods according to this invention may also address the problem of misplaced luggage after electronic check-ins. Each airport typically has a designated default bag conveyor belt, to which all unrecognized luggage is routed in case the bar-code tag attached is unreadable or does not exist. In particular, since the introduction of the electronic check-in, many passengers neglect checking in luggage at the check-in counter, and this luggage becomes “lost”. The default luggage area at each airport is assigned to an airline, usually the largest at the airport. Consequently, by having a hotspot in such default luggage area, the unidentified luggage could be localized and bar-coded, as long as the transceiver was turned on when placed inside the luggage.

### BRIEF DESCRIPTION OF DRAWINGS

In figures which illustrate non-limiting embodiments of the invention:

FIG. 1 presents main hardware building blocks for a transceiver according to an example embodiment of the invention.

FIG. 2 presents a flowchart showing a wireless registration process that may be performed at check-in.

FIG. 3 presents a state machine for the transceiver of FIG. 1.

FIG. 4 presents the different functions which may be used to implement the state machine of FIG. 3.

FIG. 5 presents a flowchart illustrating a process by which a transceiver may register with an on-board wireless LAN.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

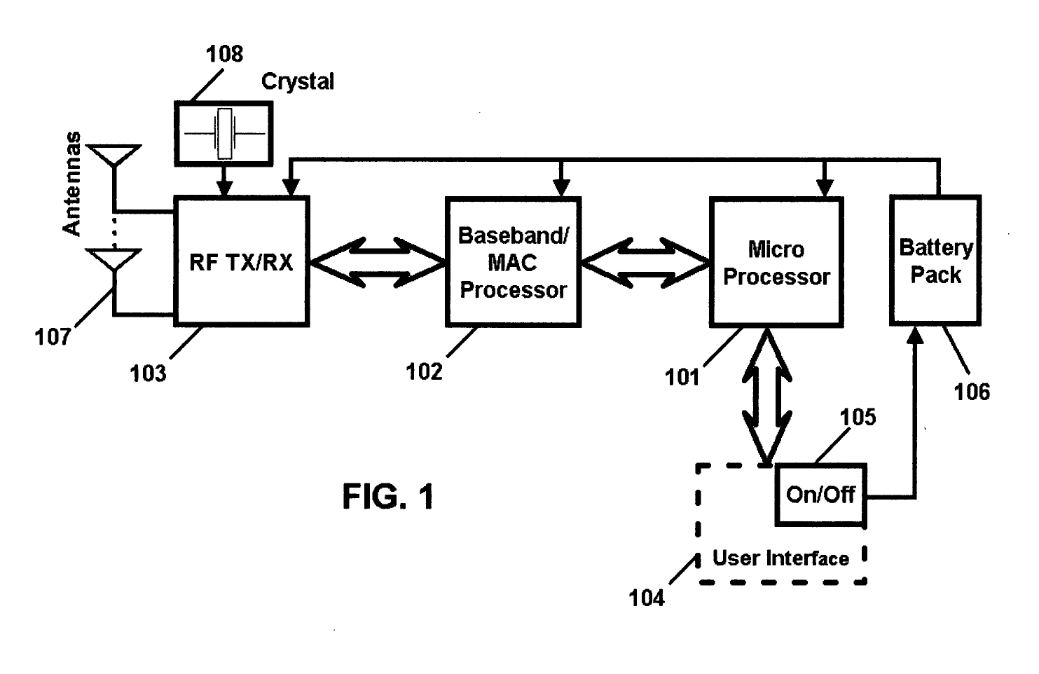

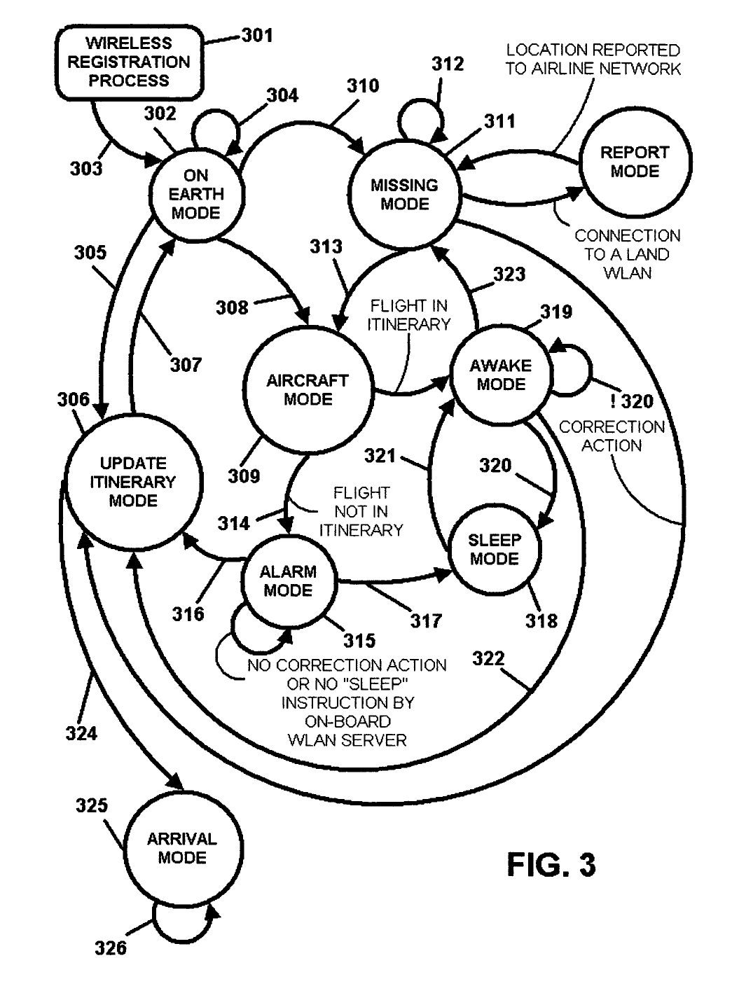

FIG. 1 is a block diagram showing main functional parts of a transceiver according to one embodiment of the invention. Its intelligence resides in the microprocessor block 101, where the transceiver's State Machine (described below with reference to FIG. 3) is implemented. The baseband/MAC processor 102 supports the RF radio transmission/reception (RF TX/RX block 103). To achieve this, it is preferable that the former may include a DC/DC converter, RAM and ROM memories, and analog-to-digital and digital-to-analog converters. In a preferred embodiment, the baseband/MAC processor 102 integrates the microprocessor 101 shown in FIG. 1. The User Interface 104 allows the passenger/airline agent to enter relevant information for the transceiver's operation as detailed before (i.e. passenger's personal information, an itinerary, etc.). The On/Off section 105 of the User Interface 104 allows turning the transceiver's power on and off. It also controls the charging of the Battery Pack 106 in case rechargeable batteries are used. Finally, it is preferable that the RF TX/RX block 103 may include more than one antenna 107 for transmission/reception. The Crystal block 108 may comprise a crystal used for frequency synthesis.

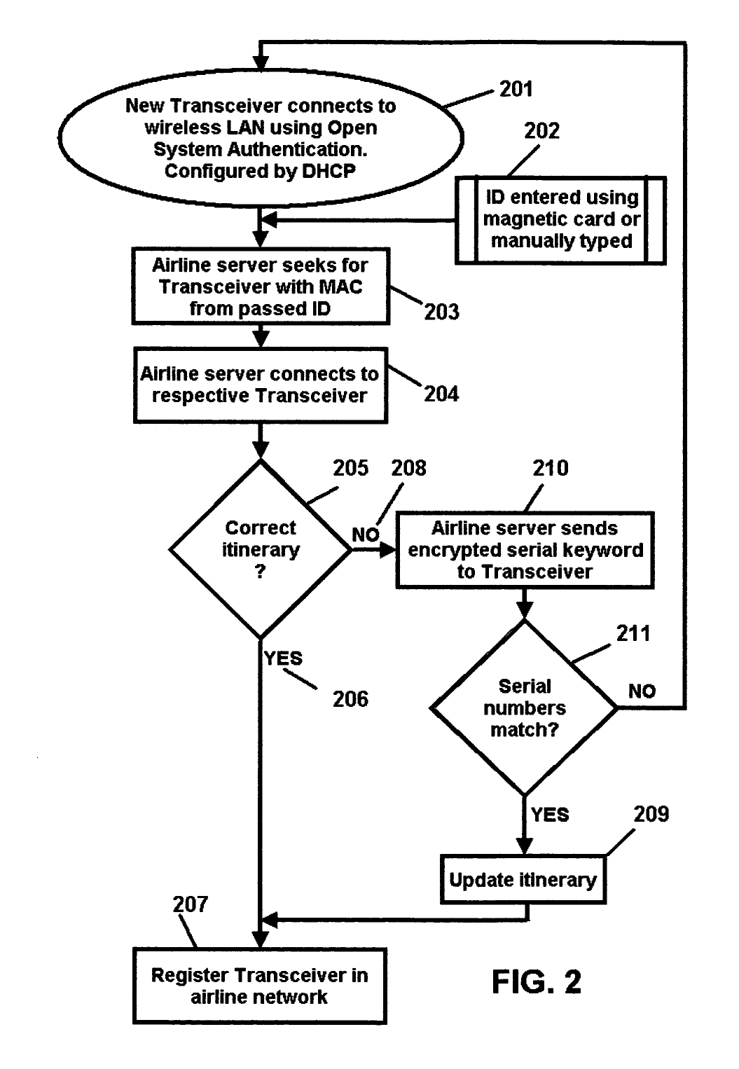

FIG. 2 is a flowchart illustrating a method, which may be performed at check-in for registering a transceiver. Each transceiver connects to the airline wireless LAN via the hotspot at the check-in terminal 201. The connection may be by means of Open System Authentication. Since this type of connection is intrinsically insecure, it is preferable that secure registration of a transceiver may be addressed in the registration protocol between the transceiver and the airline network. The preferred communication protocol supported by the transceiver may be HTTP or HTTPS. This allows for a standard, simple and widely used interface.

Security may be implemented as follows: each purchased transceiver comes with a magnetic stripe card, which contains the transceiver's ID. At check-in, the passenger hands this card to the airline agent who swipes it to obtain the ID 202 (the passenger may swipe the card himself/herself in an electronic check-in). Subsequently, the airline system broadcasts the wireless LAN seeking for the transceiver owning the MAC address from the ID supplied among all the transceivers currently associated to the wireless LAN 203. Once the correspondent transceiver answers this call, the airline system is able to automatically connect to it 204 and check if the itinerary loaded in the transceiver is correct 205. If this is the case 206, the transceiver is simply registered in the airline system 207. If the itinerary was not previously loaded or it is incorrect 208, the airline system automatically uploads the new itinerary 209. Once the correct itinerary is loaded, the transceiver is registered in the airline network. It is important to highlight that before this reconfiguration task can be accomplished, an encrypted version of the alphanumeric serial keyword must be sent to the transceiver 210. In other words, the pair MAC address-alphanumeric serial keyword, which is obtained from the magnetic card, acts as the pair user-password 211 needed to perform any configuration task over a transceiver within a non-reliable wireless LAN environment.

While the magnetic card allows the airline agent to automatically upload the itinerary and register the transceiver in the airline network (the preferred method), one of many alternative methods is to use a front-end web page to permit manual configuration of the transceiver. This can be done even when the passenger has forgotten to carry with him/her the magnetic card or when the passenger has lost the card. In such cases the passenger could hand the ID of his/her transceiver to the airline agent. A process similar to the one described above takes place once the agent enters these data into the airline network. The main difference in this case is that the front-end web page of the correspondent transceiver is shown to the airline agent. This is done in order to guarantee that the ID manually entered matches the one of the desired transceiver. Once it is confirmed that the connection was established with the correct transceiver, the itinerary could be manually entered by the agent via the web page or automatically loaded by the airline network. Similarly, this configuration task can only be accomplished if the encrypted version of the alphanumeric serial keyword is provided to the transceiver. An analogous procedure takes place in the electronic check-in case.

Once the wireless registration process is complete 301, the transceiver switches to “On Earth” Mode 302 as shown in FIG. 3. In this mode, the timers T_{ToFirStDeP} and T_{TOTAL} are calculated from the programmed itinerary and started 303, and the transceiver attempts to connect to a new hotspot once every several minutes 304. If the transceiver is able to connect to a new land hotspot 305, it checks to see whether its current itinerary needs to be updated 306. Some example reasons why an itinerary may need to be updated are:
A flight is delayed;
The passenger misses a connecting flight;
The passenger arranges an altered itinerary;
etc.
   If the itinerary is updated, the timers mentioned above are adjusted 307. On the other hand, if the transceiver is able to connect to an on-board wireless LAN 308, it switches to “Aircraft” Mode 309 (such mode will be described later on). Finally, if either of the timers T_{ToFirstDeP} or T_{TOTAL} elapse 310 while “On Earth” Mode 302, the transceiver switches to “Missing” Mode 311, where it attempts to connect to any hotspot once every several minutes to report its whereabouts 312.

The transceiver switches to “Aircraft” Mode 309 either from “On Earth” Mode 302, as explained above, or from “Missing” Mode 311, when the transceiver connects to an on-board wireless LAN (308 or 313). In the later case, the transceiver will report to the on-board wireless LAN server as missing 314, switching to “Alarm” Mode 315. The transceiver will also switch to “Alarm” Mode 315 from “Aircraft” Mode 309 if the flight is not in the itinerary. The on-board wireless LAN server will alert airline personnel who may wirelessly request the missing transceiver to “beep”, or they may use signal-strength measurements to identify its position in the aircraft luggage compartment. If airline personnel remove the luggage 316, the transceiver returns to “On Earth” Mode 302 via the “Update Itinerary” Mode 306. Else, the transceiver goes to sleep when the on-board wireless LAN server sends the instruction 317, but setting a flag to remember it is still a missing transceiver. During the flight, the “missing” transceiver will undergo the same switching between “Sleep” 318 and “Awake” 319 Modes as required by air travel regulations, until the plane arrives at its destination. The switching is at all times controlled by the on-board wireless LAN server, who programs different “sleeping times” T_{SLEEP} according to the actual flight (320 and 321). T_{SLEEP} is the total time elapsed between departure and arrival of a particular flight for aircraft without on-board Internet service).

Upon arrival, the on-board wireless LAN server (or a temporary mobile hotspot) informs all transceivers waking them up. If a transceiver did not have its “missing” flag set 322, it checks with the on-board wireless LAN server to see whether its itinerary needs to be updated or not, updates the itinerary if required, and switches to “On Earth” Mode 302. Else, it switches 323 to “Missing” Mode 311 in order to report again as missing.

Finally, when the itinerary is completed 324, the transceiver switches to “Arrival” Mode 325, where it reports its whereabouts once connected to a land wireless LAN 326. After reporting, the transceiver will attempt connections once every several minutes should airline personnel request identification.

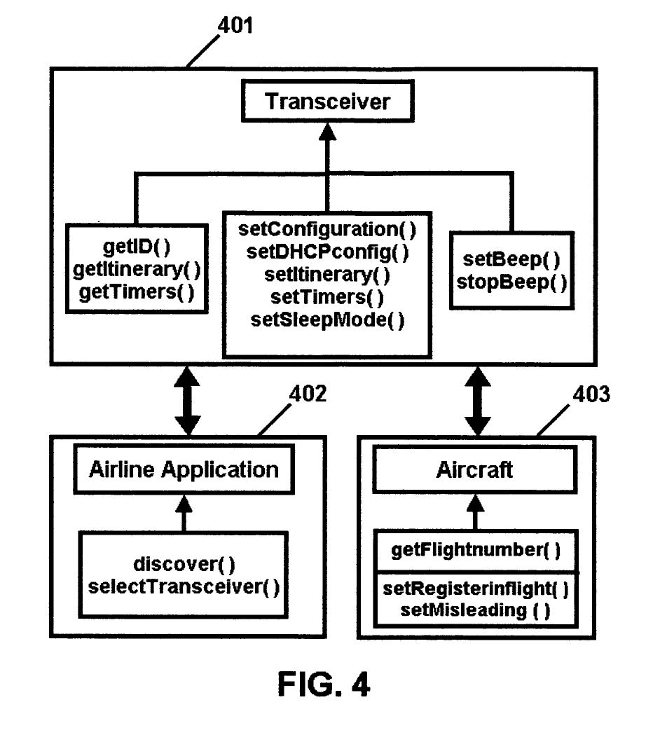

FIG. 4 presents the different functions in an example implementation of the Transceiver's State Machine. These functions can be grouped into three sets: Transceiver Registration in Airline Network and its Applications 401, Airline Application 402, and Transceiver Registration in Aircraft Network 403. The first set of functions is:

getID( ): returns the transceiver's ID, plus personal information of the owner when accessing the transceiver via USB or an alternative interface. When the transceiver is accessed via wireless LAN it only returns personal information of the owner.

getItinerary( ): returns the transceiver's loaded itinerary.

getTimers( ): calculates and returns the timers T_{TOTAL} and T_{ToFirstDep} from the loaded itinerary.

setConfiguration( ): allows to set personal information to be used by the getID( ). Such information can only be modified, via USB or an alternative interface, by entering a pin.

setDHCPconfig( ): allows the network configuration of the transceiver via DHCP.

setItinerary( ): allows updating the transceiver's itinerary.

setTimers( ): allows setting T_{TOTAL} and T_{ToFirstDep}.

setSleepMode( ): allows an on-board wireless LAN server to send the transceiver to sleep for a time T_{SLEEP} that is passed as argument. This allows saving battery power in the transceiver while providing full-control to the on-board wireless LAN server over the transceivers.

setBeep( ): allows the transceiver to “beep” upon request from the airline network. This is useful for identification of missing luggage as explained before.

stopBeep( ): allows stopping the identification beeping.

All the above functions can be either consulted/configured via Unicast or Multicast.

The second set of functions corresponds to the Airline Application. These functions are:

discover( ): allows detecting the transceivers connected to the airline wireless LAN.

selectTransceiver( ): allows the airline network to communicate with a particular transceiver.

The last set of functions corresponds to the Transceiver Registration in Aircraft Network. These functions are:

getFlightnumber( ): allows the transceiver to obtain the flight number once connected to an on-board wireless LAN. In this way the transceiver can check whether it is in the right flight or not.

setRegisterinFlight( ): allows the transceiver to register in the aircraft network. In this way the passenger is able to check whether its luggage is traveling with him/her or not.

setMisleading( ): allows the transceiver to inform the on-board wireless LAN server that the flight is not in its itinerary, and sets the alarm flag.

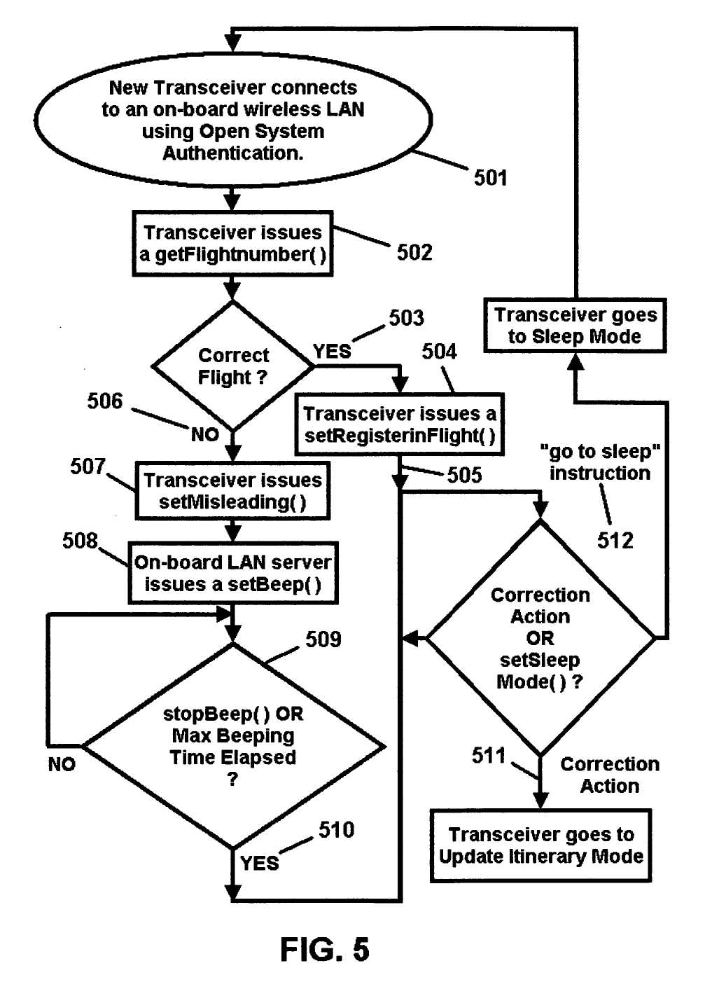

FIG. 5 is a flowchart illustrating a method, which may be used for registration of a transceiver with an on-board wireless LAN. Preferably, the transceiver connects to this wireless LAN by Open System Authentication 501. Following the connection, the transceiver issues a getFlightnumber( ) 502. If the transceiver is in the correct flight 503, the former issues a setRegisterinFlight( ) 504 and waits for the start of setSleepMode( ) 505. Else 506, if the transceiver is in the incorrect flight, the transceiver issues a setMisleading( ) 507. Following this, the on-board wireless LAN server issues a setBeep( ) 508 for airline personnel to identify the misplaced luggage (setBeep( ) may be replaced by signal-strength measurements for identification as described before), and the transceiver waits for the stopBeep( ) 509. After either receiving a stopBeep( ) or a maximum allowed internal beeping time expires 510, the transceiver waits for either a correction action by airline personnel 511 or the issue of setSleepMode( ) by the on-board wireless LAN server 512. In the former case, the transceiver switches to “On Earth” Mode (see 302 in FIG. 3) after its itinerary is updated. On the other hand, in the later case, the transceiver switches to Sleep Mode (see 318 in FIG. 3).

As will be apparent to those skilled in the art in the light of the g disclosure, many alterations and modifications are possible in the of this invention without departing from the spirit or scope thereof.

What is claimed is:

1. An automated system for self-tracking and identification of assets during air travel comprising:
wireless access points located at airports, railway stations, seaports, or any place where a check-in for air travel can take place, and aircraft; and
airports and aircraft wireless Local Area Networks (LAN); and
the airlines' flight and luggage tracking databases; and
wireless LAN transceivers which are physically associated to each asset to be tracked.

2. A system according to claim 1, wherein each wireless LAN transceiver possesses the memory capabilities of storing information such as, but not limited to, the name and address of the owner, the trip itinerary, asset description information, asset handling requirements, and destination information.

3. A system according to claim 2, wherein each wireless LAN transceiver has a unique identifier for secure registration and identification in the airline's luggage tracking database.

4. A system according to claim 3, wherein the unique identifier is implemented by the MAC address of the wireless LAN transceiver and an alphanumeric serial keyword which together implement a user-password registration and access scheme.

5. A system according to claim 2, wherein the unique identifier is provided by a magnetic card that comes with each transceiver.

6. A system according to claim 2, wherein all information to be stored is wirelessly uploaded onto the transceiver by means of a personal computer, a PDA, a cell phone, or other technical device.

7. A system according to claim 2, wherein all information to be stored is uploaded onto the transceiver by means of a wired connection to a personal computer, a PDA, a cell phone, or other technical device.

8. A system according to claim 2, wherein all information to be stored is manually uploaded onto the transceiver by using an alternative interface.

9. A system according to claim 2, wherein the trip itinerary is uploaded onto the transceiver by performing an automatic download from the airline's web page using the passenger's frequent flyer number.

10. A system according to claim 3, wherein the trip itinerary is wirelessly uploaded onto the transceiver at airport check-in during secure registration with the airline's luggage tracking database.

11. A system according to claim 3, wherein each transceiver utilizes any of the IEEE 802.11 standards for wireless communication with the wireless access points at airports and aircraft.

12. A system according to claim 11, wherein each transceiver connects to the wireless access points at airports and aircraft by means of Open System Authentication.

13. A system according to claim 12, wherein each transceiver's communication protocol is either HTTP or HTTPS.

14. A system according to claim 3, wherein each transceiver has at least one processor and control software for execution by the processor, wherein the control software includes instructions which cause the processor of each registered transceiver to receive flight information from a wireless access point by means of its wireless interface.

15. A system according to claim 14, wherein each transceiver connects to the wireless access point with the strongest radio signal when more than one of the latter is present.

16. A system according to claim 15, wherein each transceiver has the capability to update its stored itinerary after receiving new flight information, either by means of a Unicast or a Multicast connection.

17. A system according to claim 16, wherein each transceiver compares the flight information received with its stored itinerary and generates an alarm condition if the flight information does not match the stored trip itinerary.

18. A system according to claim 17, wherein the control software of each transceiver possesses at least two timers that are initiated and updated from the stored trip itinerary. The first timer allows each transceiver to compare its value to information in the stored trip itinerary indicative of a time when the transceiver ought to be on an aircraft. The second timer allows each transceiver to keep track of the total time elapsed since the start of the stored trip itinerary.

19. A system according to claim 18, wherein an alarm condition is also generated if any of the timers elapses.

20. A system according to claim 19, wherein each transceiver reports its alarm condition to airline personnel or the airline's luggage tracking database immediately following the generation of the alarm condition.

21. A system according to claim 15, wherein airline personnel can request the transceiver to beep for identification or determine its position by signal-strength measurements from at least two nearby wireless access points.

22. A system according to claim 14, wherein each transceiver can be instructed to enter “sleep mode” while connected to a wireless access point.

23. A system according to claim 22, wherein communication to and from a transceiver in sleep mode is controlled at all times by the wireless access points at airports and in aircraft hence complying with air travel regulations pertaining on-board electronic devices.

24. A system according to claim 3, wherein the owner of a transceiver can check its whereabouts by connecting to the airline's luggage tracking database via the Internet.

25. A system according to claim 3, wherein the owner of a transceiver can be notified by e-mail, SMS message or any other type of technical communication of the asset's whereabouts.

26. A system according to claim 24, wherein the owner of a transceiver can initiate tracking initiatives if his or her asset is misdirected during the trip.

27. A system according to claim 1, wherein each wireless LAN transceiver can be powered using any type of battery.

28. A system according to claim 1, wherein each wireless LAN transceiver includes at least one antenna for transmission and one for reception, being possible to use the same antenna for both operations.
